(19) United States
(12) Patent Application Publication
(10) Pub. No.: US 2018/0157892 A1
(43) Pub. Date: Jun. 7, 2018

(54) EYE DETECTION METHOD AND APPARATUS

(71) Applicant: Samsung Electronics Co., Ltd., Suwon-si (KR)

(72) Inventors: Jae Joon Han, Seoul (KR); Changkyo Lee, Seoul (KR); Wonjun Hwang, Seoul (KR); Jung Bae Kim, Seoul (KR)

(73) Assignee: Samsung Electronics Co., Ltd., Suwon-si (KR)

(21) Appl. No.: 15/818,924

(22) Filed: Nov. 21, 2017

(30) Foreign Application Priority Data
Dec. 1, 2016 (KR) 10-2016-0162553

(51) Int. Cl. G06K 9/00; G06N 3/08; G06K 9/46; G06K 9/20

(52) U.S. Cl. CPC G06K 9/0061; G06N 3/08; G06K 9/2018; G06K 9/00617; G06K 9/4628; G06K 9/00604

(57) ABSTRACT

An eye detection method and apparatus based on depth information. The eye detection method includes inputting an image to a trained deep neural network and acquiring eye position information included in the image based on an output of the deep neural network.

### CROSS-REFERENCE TO RELATED APPLICATION(S)

This application claims the benefit under 35 U.S.C. § 119(a) of Korean Patent Application No. 10-2016-0162553, filed on Dec. 1, 2016, in the Korean Intellectual Property Office, the entire disclosure of which is incorporated herein by reference for all purposes.

### BACKGROUND

### 1. Field

The following description relates to an eye detection method and apparatus.

### 2. Description of Related Art

Recently, due to the importance of security, biometric authentication is being developed as an authentication scheme for banking or shopping via devices, or for unlocking devices. Typically, a biometric authentication includes, for example, a fingerprint authentication, facial recognition, or iris recognition. Iris recognition is performed by detecting an eye area from an infrared image and segmenting and recognizing the detected area. In an eye detection process, a multi-block local binary pattern (MB-LBP) may be used. The MB-LBP may be used to calculate an LBP value based on various block sizes, and an adaptive boosting (AdaBoost)-based cascade classifier may be used for the MB-LBP.

### SUMMARY

This Summary is provided to introduce a selection of concepts in a simplified form that are further described below in the Detailed Description. This Summary is not intended to identify key features or essential features of the claimed subject matter, nor is this Summary intended to be used as an aid in determining the scope of the claimed subject matter.

In one general aspect, a processor-implemented eye detection method includes acquiring an infrared image, and detecting an area including one or more eyes in the infrared image using a trained deep neural network including a plurality of hidden layers.

The trained neural network may be an interdependent multi-level neural network configured to detect a depth of the one or more eyes detected in the area.

The method may further include controlling an exposure of a captured image and/or of a next captured image by an image sensor based on the detected depth.

The multi-level neural network may include a first neural network provided the infrared image and configured to detect the depth and a second neural network provided the infrared image and the detected depth and configured to detect eye coordinates.

The method may further include inputting, to a neural network, training data classified by a depth of a training subject in an image, the depth of the training subject representing a distance between the training subject and a camera that captured the training data, and adjusting parameters of the neural network until the neural network outputs eye position information included in the training data with a predetermined confidence level, to generate the trained neural network.

The trained neural network may be configured to detect the area from the infrared image based on information about a distance between a subject in the infrared image and a camera that captures the infrared image, and the information about the distance is included in the infrared image. The information about the distance may include information about a size of the one or more eyes in the infrared image.

The trained neural network may be configured to simultaneously determine, based on an input of the infrared image, at least two of a distance between a subject in the infrared image and a camera that captures the infrared image, a number of eyes included in the infrared image, or corresponding position(s) of the eye(s).

The detecting may include inputting the infrared image to the neural network, and determining coordinates indicating a position of the area in the infrared image based on an output of the neural network.

In another general aspect, there is provided a non-transitory computer-readable storage medium storing instructions that, when executed by a processor, cause the processor to implement one or more, any combination, or all operations described herein.

In another general aspect, a processor-implemented eye detection method includes inputting an image to a first neural network, acquiring a number of eyes included in the image, the number of the eyes being output from the first neural network, inputting the image to a second neural network, and acquiring, as output from the second neural network, eye position information that corresponds to the number of the eyes, and depth information that represents a distance between a subject in the image and a camera that captures the image.

The eye detection method may further include controlling an exposure of the image based on at least one of the number of the eyes or the depth information. The eye detection method may further include inputting the image with the controlled exposure to the first neural network, and acquiring eye position information included in the image with the controlled exposure based on an output of the first neural network in association with the image with the controlled exposure. In response to an eye being determined to be included in the image, the second neural network may be configured to output position information of a candidate object with a highest probability of corresponding to the eye among candidate objects estimated as the eye. In response to two eyes being determined to be included in the image, the second neural network may be configured to output position information of two candidate objects with highest probabilities of corresponding to the eyes among candidate objects estimated as the eyes.

In still another general aspect, a processor-implemented eye detection method includes inputting an image to a first neural network, acquiring depth information of a subject in the image and a number of eyes included in the image, the depth information and the number of the eyes being output from the first neural network, inputting the image and the depth information to a second neural network, and acquiring eye position information that corresponds to the number of the eyes and that is output from the second neural network.

The eye detection method may further include controlling an exposure of the image based on any one or combination of the number of the eyes or the depth information. The eye detection method may further include inputting the image with the controlled exposure to the first neural network, and acquiring eye position information included in the image with the controlled exposure based on an output of the first neural network in association with the image with the controlled exposure.

In response to an eye being determined to be included in the image, the second neural network may be configured to output position information of a candidate object with a highest probability of corresponding to the eye among candidate objects estimated as the eye. In response to two eyes being determined to be included in the image, the second neural network may be configured to output position information of two candidate objects with highest probabilities of corresponding to the eyes among candidate objects estimated as the eyes.

In a further general aspect, a processor-implemented training method includes inputting, to a neural network, training data classified by a depth of a subject in the image, the depth representing a distance between the subject and a camera that captured the training data, and adjusting a parameter of the neural network so that the neural network outputs eye position information included in the training data.

The adjusting may include adjusting the parameter of the neural network so that the neural network simultaneously determines at least two of a number of eyes included in the training data, positions of the eyes or the depth.

The inputting may include inputting the training data to each of a first neural network and a second neural network that are included in the neural network. The adjusting may include adjusting a parameter of the first neural network so that the first neural network outputs a number of eyes included in the training data, and adjusting a parameter of the second neural network so that the second neural network outputs the depth and eye position information that corresponds to the number of the eyes.

The inputting may include inputting the training data to each of a first neural network and a second neural network that are included in the neural network. The adjusting may include adjusting a parameter of the first neural network so that the first neural network outputs the depth and a number of eyes included in the training data, further inputting the depth to the second neural network, and adjusting a parameter of the second neural network so that the second neural network outputs eye position information that corresponds to the number of the eyes based on the depth.

In still another general aspect, an eye detection apparatus includes a sensor configured to capture an infrared image, and a processor configured to detect an area including one or more eyes in the infrared image using a trained deep neural network including a plurality of hidden layers. The trained neural network may be configured to detect the area from the infrared image based on information about a distance between the subject of the infrared image and the sensor that captures the infrared image, and the information about the distance is included in the infrared image.

Other features and aspects will be apparent from the following detailed description, the drawings, and the claims.

### BRIEF DESCRIPTION OF THE DRAWINGS

FIG. 1 is a diagram illustrating an example of an eye detection apparatus.

FIG. 2 is a diagram illustrating an example of a structure of a single-level neural network.

FIG. 3 is a diagram illustrating an example of a multi-level neural network.

FIG. 4 is a diagram illustrating an example of a structure of a multi-level neural network.

FIG. 5 is a diagram illustrating an example of multi-level neural network.

FIG. 6 is a diagram illustrating an example of a structure of a multi-level neural network.

FIG. 7 is a block diagram illustrating an example of a training apparatus.

FIG. 8 is a diagram illustrating an example of training data.

FIG. 9 is a diagram illustrating an example of an exposure control based on a depth.

FIG. 10 is a diagram illustrating an example of an exposure-controlled image.

FIG. 11 is a block diagram illustrating an example of an eye detection apparatus.

FIG. 12 is a flowchart illustrating an example of an eye detection method.

FIG. 13 is a flowchart illustrating an example of a training method.

Throughout the drawings and the detailed description, unless otherwise described or provided, the same drawing reference numerals will be understood to refer to the same or like elements, features, and structures, where applicable. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the application. The sequences of operations described herein are merely examples, and are not limited to those set forth herein, but may be changed as will be apparent to one skilled in the art, with the exception of operations necessarily occurring in a certain order. Also, descriptions of functions and constructions that are well known may be omitted for increased clarity or conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions are exemplary to merely describe the examples, and the scope of the examples is not limited to the descriptions provided in the present specification. Various changes and modifications can be made thereto by those skilled in the relevant art.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

As used herein, the singular forms are intended to include the plural forms as well, unless the context clearly indicates otherwise. It should be further understood that the terms “comprises” and/or “comprising,” when used in this specification, specify the presence of stated features, integers, operations, elements, components or a combination thereof, but do not preclude the presence or addition of one or more other features, integers, operations, elements, components, and/or groups thereof.

Unless otherwise defined herein, all terms used herein including technical or scientific terms have the same meanings as those generally understood by one skilled in the art consistent with the present disclosure. Terms defined in dictionaries generally used should be construed to have meanings matching with contextual meanings in the related art and the present disclosure and are not to be construed as an ideal or excessively formal meaning unless otherwise defined herein.

Hereinafter, examples will be described in detail with reference to the accompanying drawings, and like reference numerals in the drawings refer to like elements throughout.

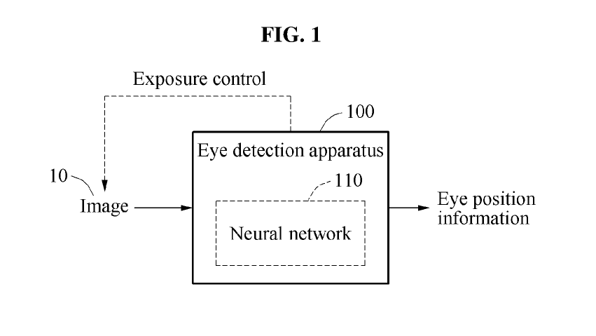

FIG. 1 illustrates an example of an eye detection apparatus 100. Referring to FIG. 1, the eye detection apparatus 100 receives an image 10 as an input, and detects an area including one or more eyes in the image 10. The eye detection apparatus 100 outputs eye position information as a detection result. The eye detection apparatus 100 includes one or more processors, such that one or more or all operations described herein may be implemented by hardware of the one or more processors specially configured to implement such operations or a combination of the hardware and/or non-transitory computer readable media storing instructions, which when executed by the one or more processors, cause the one or more processors to implement such one or more or all operations.

The eye position information includes coordinates indicating a position of the detected area (for example, coordinates indicating a vertex of the detected area when the detected area has a polygonal shape), and coordinates indicating a center position of the detected area. The center position of the detected area corresponds to, for example, a center of an eye.

The eye detection apparatus 100 detects the area including the eyes in the image 10 based on a neural network 110. To detect an area including eyes of a subject, the eye detection apparatus 100 inputs the image 10 to the neural network 110 and determines coordinates indicating a position of the area based on an output of the neural network 110.

The image 10 includes, for example, an infrared image. However, in other examples substantially the same or like operations as described herein may be performed even when the image 10 is an image (for example, a color image) other than the infrared image. In addition, examples include operations that consider the infrared image with the neural network 110 to determine information about the infrared image, such as a depth of a subject or eyes determined to be included in the infrared image, and operations that further include considering that determined depth with other operations in addition to the infrared image or a next to-be captured infrared image, such as with controlling an exposure of the infrared image or the next to-be captured infrared image and/or controlling an exposure of a concurrently captured color image or next to-be captured color image by the eye detection apparatus 100. Examples further include the eye detection apparatus 100 further performing eye verification, rejection, and/or identification based on the detected area of the one or more eyes determined in the image 10.

The neural network 110 is configured to detect the area including the eyes from the image 10 based on information about a distance between the subject and a camera that captures the image 10. The information about the distance is included in the image 10. For example, the information about the distance includes information about size(s) of the eye(s) in the image 10.

The neural network 110 is configured by having been trained in advance based on training data, to output eye position information included in the training data. The training data is classified by a depth of one or more training subjects. The training of the neural network may include determining hyper-parameters, such as parameters that define the structure of the neural network, and recursively training parameters, such as trained connection weights or trained kernel matrices, until the neural network properly classifies information about the training data, e.g., within a predetermined confidence level or percentage. Accordingly, the trained neural network 110 outputs eye position information included in the image 10 based on depth information of the subject. In the following description, the depth information represents the distance between the subject and the camera that captures the image 10.

As noted, the neural network 110 is trained in advance using machine learning, for example, through deep learning training. Feature layers are extracted from the neural network 110 using a supervised learning or unsupervised learning in the deep learning. For example, the parameters of an untrained neural network may be first set to have random values, and then repeatedly adjusted until the output of the neural network is trained for the desired objective. A neural network with more than one hidden layer, e.g., with an input layer, two or more hidden layers, and an output layer, may be referred to as a deep neural network. Thus, the neural network 110 may, for example, also be a multi-layer neural network, and thus a deep neural network. The multi-layer neural network may include a fully connected network of one or more dense or fully connected layers, a convolutional network of one or more convolutional layers, and/or one or more recurrent layers and/or recurrent connections. When plural such neural networks, or combination of networks, are implemented with one or more other neural networks, or combination of networks, then the respective neural network, or combination of networks, may be referred to as being of different levels.

Each of a plurality of layers included in the neural network 110 includes a plurality of nodes, with the nodes being connected to other nodes, e.g., through connection weightings. The other nodes may be located in the same layer as that of the nodes and/or in different layers from those of the nodes. As noted, the neural network 110 includes multiple layers. For example, the neural network 110 corresponds to an input layer and includes an intermediate layer and an output layer, with the intermediate layer being referred to herein as a “hidden layer.” Nodes included in layers other than the output layer are connected via the aforementioned weighted connections to transmit an output signal to nodes included in a next layer. For example, in a fully connected neural network, a number of the weighted connections may correspond to a number of the nodes included in the next layer.

The neural network 110 may be implemented as, for example, a feedforward network. For example, each node included in the feedforward network may be connected to all nodes in a next layer so that the fully connected network is formed, or has a limited spatial connectivity as in a convolutional network. Each of nodes included in the neural network 110 may implement a linear combination of outputs from nodes included in a previous layer, e.g., where the outputs have been multiplied by a connection weight. The sum of these weighted inputs (outputs from previous layer) is input to an activation function. The activation function is used to calculate an output of node based on the sum of the weighted inputs. For example, the activation function may have a non-linear characteristic.

Accordingly, the neural network 110 may be a trained neural network trained to output positions of the eyes in the image 10 in response to the input of the image 10. The neural network 110 may be further trained to output at least one of a number of eyes included in the image 10 or the depth information. For example, in response to the input of the image 10, the neural network 110 may be trained to simultaneously output the number of eyes in the image 10, the positions of the eyes in the image 10, and the depth information. In this example, the neural network 110 may include output nodes to output the depth information and the depth information. As described above, the training data may be pre-classified or labeled according to the depth of one or more training subjects.

Depth has an influence on a size of a subject's face in the image 10 and an exposure of the image 10. Knowledge of the depth may be used for an eye detection, and accordingly an accuracy of the eye detection may be enhanced. Thus, an output node configured to output the depth information may also have an influence on the parameter operations of the neural network 110 to determine eye position information. Accordingly, in response to the neural network 110 outputting the depth information, the depth information may be reapplied into the neural network 110 and an accuracy of eye position information may also be enhanced.

The neural network 110 has various structures to output at least one of the number of the eyes, the positions of the eyes, or the depth information. In an example, the neural network 110 has a single-level network structure to simultaneously determine the number of the eyes, the positions of the eyes, and the depth information, in response to the input of the image 10. In a multi-level example, the neural network 110 includes a first neural network and a second neural network. In this example, in response to the input of the image 10, the first neural network simultaneously determines at least two of the number of the eyes, the positions of the eyes, or the depth information, and the second neural network determines one or more of which ever of the at least two of the number of the eyes, the positions of the eyes, or the depth information that was not determined by the first neural network. If the second neural network is dependent on outputs of the first neural network, or is trained based on training output of the first neural network, then the multi-level neural network may be considered an interdependent multi-level neural network. The first neural network and the second neural network are referred to as a “multi-level network structure.” In this following description, a term “level” is understood as a concept corresponding to a number of neural networks used to detect an eye, for example, and is distinct from the aforementioned use of the term “layer” to refer to a layer nodal concept of a neural network structure.

In an example, the neural network 100 includes a first neural network to output the number of the eyes in the image 10, and a second neural network to output the depth information and eye position information that corresponds to the number of the eyes. In another example, the neural network 100 includes a first neural network to output the number of the eyes in the image 10 and the depth information, and a second neural network to output eye position information that corresponds to the number of the eyes based on the depth information. Operations of the first neural network and the second neural network will be further described below.

The exposure of the image 10 has an influence on the accuracy of the eye detection. For example, when the image 10 is overexposed due to a decrease in a distance between a subject and a camera and when the image 10 is underexposed due to an increase in the distance between the subject and the camera, the accuracy of the eye detection is reduced. The eye detection apparatus 100 controls the exposure of the image 10 based on the number of the eyes in the image 10 or the depth of the subject. For example, when an eye is not detected in the image 10, the eye detection apparatus 100 controls the exposure of the image 10.

As only an example, the neural network 110 may output the number of eyes in the image 10 as “1” or “2” based on whether a single eye or two eyes are detected from the image 10. When an eye is not detected in the image 10, the neural network 110 outputs the number of the eyes as zero, which indicates that a subject does not exist in front of a camera, or that the image 10 is overexposed or underexposed even though a subject might be in front of the camera. For example, when an eye is not detected in the image 10, the eye detection apparatus 100 may be configured to controls the exposure of the image 10 to allow an eye to be detected from the image 10 or to enhance an accuracy of a position of a detected eye.

Also, the eye detection apparatus 100 controls the exposure of the image 10 based on the depth information that represents the distance between the subject and the camera that captures the image 10. In an example, when the depth of the subject exceeds a predetermined first threshold, the eye detection apparatus 100 increases the exposure of the image 10. In this example, when the depth is less than a predetermined second threshold, the eye detection apparatus 100 reduces the exposure of the image 10. The first threshold is greater than the second threshold. In another example, an appropriate exposure value based on a depth is set in advance, and the eye detection apparatus 100 controls the exposure of the image 10 using an appropriate exposure value based on the depth of the subject. An exposure control based on the number of eyes and an exposure control based on the depth are simultaneously or selectively performed.

When the exposure of the image 10 is controlled, the eye detection apparatus 100 inputs an image with the controlled exposure (hereinafter, referred to as an “exposure-controlled image”) to the first neural network 110, and acquires a number of eyes included in the exposure-controlled image based on an output of the first neural network 110 in association with the exposure-controlled image. The controlling of the exposure of the image 10 includes both controlling an exposure of an image of a current frame captured by a camera and input to the eye detection apparatus 100, and controlling settings of the camera to control an exposure of an image of a next frame.

For example, when the neural network 110 includes a first neural network and a second neural network, the eye detection apparatus 100 inputs, to the second neural network, the image 10 and a number of eyes that is output from the first neural network, and acquires eye position information that is output from the second neural network. In this example, the position information output from the second neural network corresponds to the number of the eyes output from the first neural network. When the number of eyes in the image 10 is “1,” the second neural network outputs position information of a single eye. For example, when a single eye is included in the image 10, the second neural network outputs position information of a candidate object with a highest probability of corresponding to the eye among candidate objects estimated as the eye. When two eyes are included in the image 10, the second neural network outputs position information of two candidate objects with highest probabilities of corresponding to the eyes among candidate objects estimated as the eyes.

The eye position information includes, for example, eye center coordinates indicating a center of an eye, and eye area coordinates indicating an area including an eye. In an example, the eye center coordinates include a pair of x and y coordinates, and the eye area coordinates include a pair of x and y coordinates indicating an upper left portion of the area and a pair of x and y coordinates indicating a lower right portion of the area. Accordingly, three pairs of coordinates in total are output per eye as eye position information. In another example, the area is specified by a height and a width of the area and a pair of x and y coordinates indicating a reference point, for example, the upper left portion of the area. The eye position information is utilized in biometric authentication, for example, in iris recognition subsequently performed by the eye detection apparatus 100. An iris is accurately recognized regardless of a distance, and accordingly an inconvenience of needing to match an eye position to a predetermined interface during iris recognition is reduced.

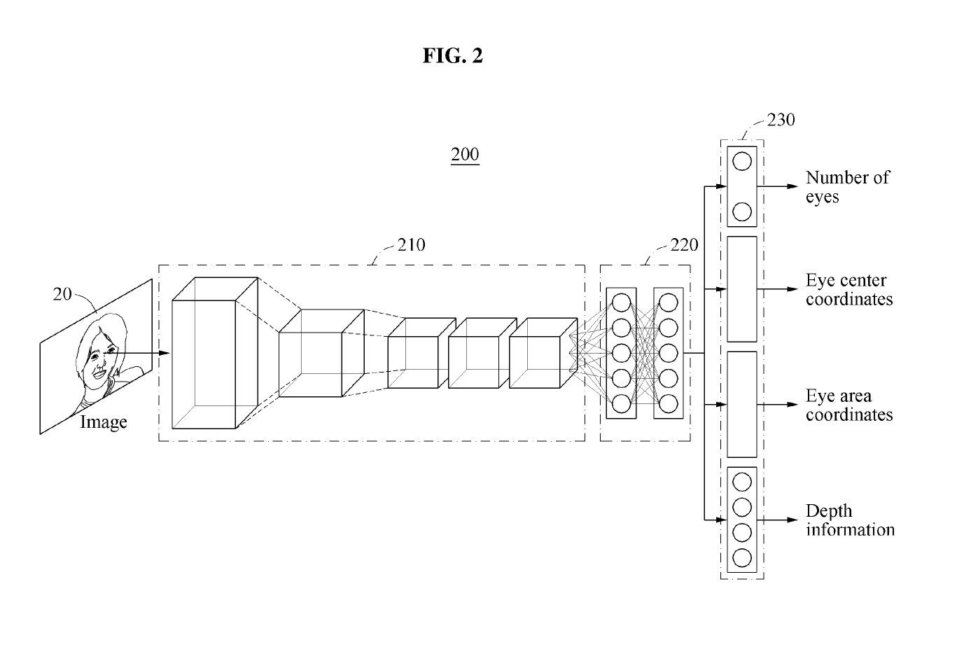

FIG. 2 illustrates an example of a structure of a single-level neural network 200 (hereinafter, referred to as a “neural network 200”). Referring to FIG. 2, the neural network 200 includes a feature extractor 210, a classifier 220, and an output layer 230. The structure of the neural network 200 of FIG. 2 is merely an example and is not limited thereto.

The feature extractor 210 receives an image 20 as an input, and extracts a feature vector from the image 20. For example, the feature extractor 210 includes a convolutional network including a plurality of convolutional layers. An input convolutional layer of the feature extractor 210 generates a feature map of the image 20 by performing a convolution of the image 20 and at least one trained kernel matrix, e.g., scanning the image 20 using the at least one kernel matrix, and transmits or makes available the feature map to a next convolutional layer. Before the feature map is transmitted or made available to the next convolutional layer, sub-sampling of the feature map may be implemented, referred to as pooling. For example, max pooling may be applied for extracting a maximum value from each of plural particular windows having a predetermined size. Thus, the result of the sub-sampling may be a lesser dimensioned representation of the feature map.

Each of the other convolutional layers of the feature extractor 210 may generate their respective feature maps by performing convolution on the output feature maps of the previous layer, e.g., after the respective sub-samplings have been performed, each convolution using at least one trained kernel matrix. The kernel matrices may act as filters, so the convolution of a kernel matrix with an input image or feature map may result in a feature map representing an extracted feature of that input image or feature map based on the kernel matrix. Based on a number of kernel matrices used by each of the layers of the feature extractor 210, each layer may generate a plurality of feature maps, which are each acted on by the subsequent layer. The last layer of the feature extractor 210 transmits or makes available the last generated feature maps, e.g., after any sub-sampling, to the classifier 220. Each of the trained kernel matrices of the feature extractor 210 may be considered parameters of the feature extractor 210 or the neural network 200.

The classifier 220 classifies features of the image 20 based on an input feature vector, for example. In an example, the classifier 220 includes a fully connected neural network including a plurality of layers. Each of a plurality of layers included in the classifier 220 receives weighted inputs from a previous layer, and transmits or makes available an output to a next layer based on a sum of the weighted inputs and an activation function of a corresponding node of the particular. As noted above, the applied weights that are applied to the inputs are trained in advance during the training of the neural network 200, as trained connection weights, which are also considered to be parameters of the classifier 220 or the neural network 200.

A classification result of the classifier 220 is transferred or made available to the output layer 230. For example, the output layer 230 forms a portion of the classifier 220. In this example, the plurality of layers in the classifier 220 correspond to intermediate layers or hidden layers of a fully connected network. The output layer 230 outputs, based on the classification result, at least one of a number of eyes included in the image 20, eye center coordinates of the eyes in the image 20, eye area coordinates of the eyes in the image 20, or depth information of the subject. For example, the output layer 230 further includes an additional module for a softmax function. In this example, a number of eyes, eye position information, and depth information are output based on the softmax function.

The output layer 230 outputs the number of eyes in the image 20 based on an output of the classifier 220. For example, the number of the eyes is output as “0,” “1” or “2.” The output layer 230 outputs, based on the output of the classifier 220, the depth information and eye position information that includes the eye center coordinates and the eye area coordinates. The depth information includes a depth level corresponding to a depth of the subject among a preset number of depth levels, for example. For example, when four depth levels are pre-defined, the depth information includes a depth level corresponding to the depth of the subject among the four depth levels.

The output layer 230 outputs the eye position information that corresponds to the number of the eyes. In an example, when a single eye is included in the image 20, the output layer 230 outputs position information of a candidate object with a highest probability of corresponding to the eye among candidate objects estimated as the eye. In another example, when two eyes are included in the image 20, the output layer 230 outputs position information of two candidate objects with highest probabilities of corresponding to the eyes among candidate objects estimated as the eyes.

The neural network 200 is trained in advance based on training, to output depth information of a subject associated with the image 20 and eye position information included in the image 20. The training data is pre-classified by the depth of the subject. In supervised learning, labels for learning are assigned to training data, and the neural network 200 is trained based on the training data with the assigned labels according to the depth of the subject. An example of training data will be further described below. The depth information output by the neural network 200 is used to control an exposure of the image 20.

Parameters of the neural network 200 trained to output the eye position information may be different from parameters of the neural network 200 trained to output the eye position information and the depth information, because an addition of the depth information as an output of the neural network 200 has an influence on the parameters of the neural network 200, e.g., during training. When the neural network 200 is trained to output the depth information based on training data classified by the depth, an accuracy of the eye position information output from the neural network 200 is enhanced, in comparison to when the neural network 200 is trained regardless of the depth.

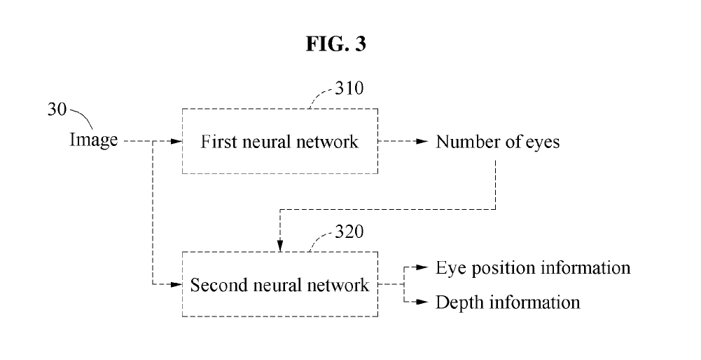

FIG. 3 illustrates an example of a multi-level neural network. Referring to FIG. 3, a first neural network 310 receives an image 30 as an input and outputs a number of eyes included in the image 30. The first neural network 310 is trained in advance. A second neural network 320 receives, as inputs, the image 30 and the number of the eyes, and outputs depth information of a subject that is associated with the image 30 and eye position information that corresponds to the number of the eyes.

The second neural network 320 is trained in advance based on training data classified by a depth of one or more training subjects, to output the depth information and the eye position information. For example, the second neural network 320 is trained based on training data to which labels are assigned based on the depth. An example of training data will be further described below. The depth information output by the second neural network 320 is used to control an exposure of the image 30.

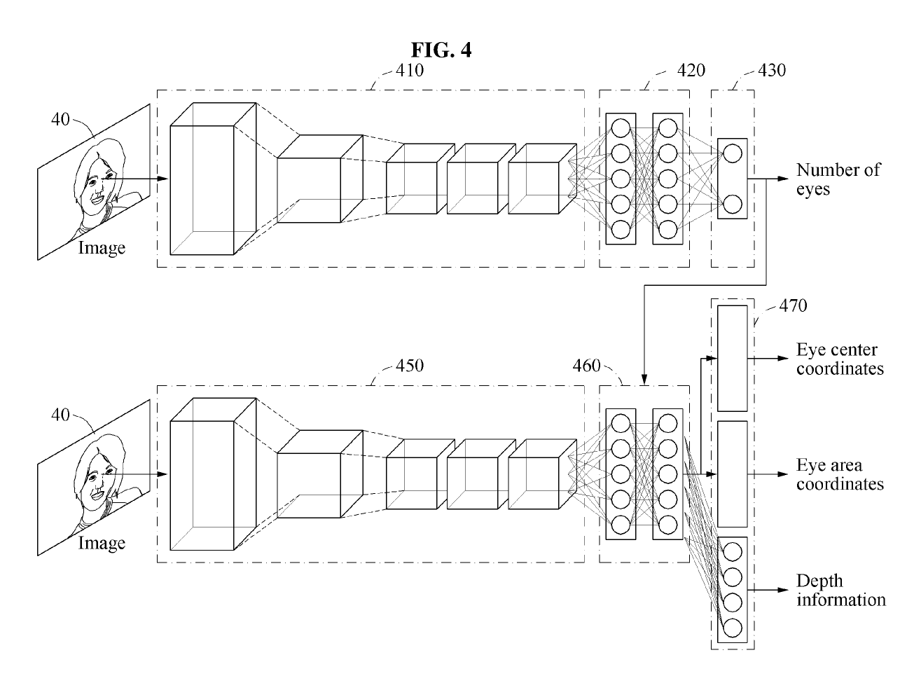

FIG. 4 illustrates an example of a structure of a multi-level neural network. Referring to FIG. 4, respectively or collectively trained in advance, the multi-level neural network includes a first neural network includes a feature extractor 410, a classifier 420, and an output layer 430, and a second neural network includes a feature extractor 450, a classifier 460 and an output layer 470. Structures of the first neural network and the second neural network of FIG. 4 are merely examples and are not limited thereto.

The feature extractors 410 and 450 each include a convolutional network including a plurality of layers. The classifiers 420 and 460 each include a plurality of layers that form a fully connected network. The description of FIG. 2 is applicable to the feature extractors 410 and 450 and the classifiers 420 and 460, and thus the description of FIG. 2 is incorporated herein.

The output layer 430 outputs a number of eyes included in an image 40 based on an output of the classifier 420. The classifier 460 receives the number of the eyes from the output layer 430, and the output layer 470 outputs eye position information that corresponds to the number of the eyes received from the output layer 430. For example, when a single eye is included in the image 40, the output layer 470 outputs position information of a candidate object with a highest probability of corresponding to the eye among candidate objects estimated as the eye. When two eyes are included in the image 40, the output layer 470 outputs position information of two candidate objects with highest probabilities of corresponding to the eyes among candidate objects estimated as the eyes.

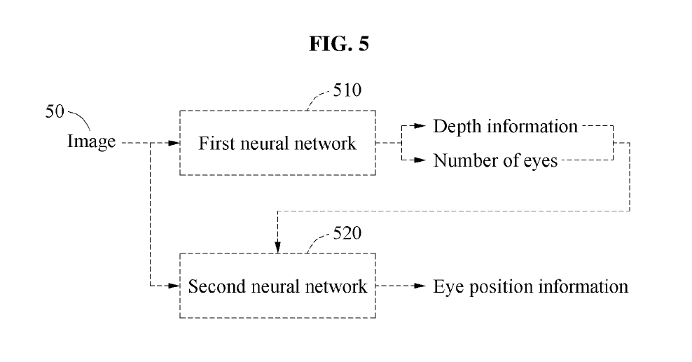

FIG. 5 illustrates an example of a multi-level neural network. Referring to FIG. 5, respectively or collectively trained in advance, the multi-level neural network includes a first neural network 510 that receives an image 50 as an input and is configured to output depth information of a subject and a number of eyes included in the image 50, and a second neural network 520 that receives, as inputs, the image 50, the depth information, and the number of the eyes, and is configured to output eye position information that corresponds to the number of the eyes.

For example, the second neural network 520 is trained in advance based on training data including depth information, to output the eye position information. For example, the second neural network 520 may be trained based on training data that includes a training image and depth information of the training image. In this example, an accuracy of the eye position information output by the second neural network 520 is enhanced in response to the second neural network 520 being trained based on the depth information, in comparison to when a depth of an object is not taken into consideration. As described above, the depth information output by the second neural network 520 is used to control an exposure of the image 40.

FIG. 6 illustrates an example of a structure of a multi-level neural network. Referring to FIG. 6, respectively or collectively trained in advance, the multi-level neural network includes a first neural network includes a feature extractor 610, a classifier 620, and an output layer 630, and a second neural network includes a feature extractor 650, a classifier 660, and an output layer 670. Structures of the first neural network and the second neural network of FIG. 6 are merely examples and are not limited thereto.

The feature extractors 610 and 650 each include a convolutional network including a plurality of layers. The classifiers 620 and 660 and the output layers 630 and 670 each include a fully connected network. The description of FIG. 2 is applicable to the convolutional network and the fully connected network, and thus the description of FIG. 2 is incorporated herein. The output layer 630 outputs a number of eyes included in an image 60 based on an output of the classifier 620. The output layer 670 outputs eye position information that includes eye center coordinates and eye area coordinates, based on an output of the classifier 660.

The feature extractor 650 receives depth information from the output layer 630, and extracts a feature from the image 60 based on the depth information. The depth information is input to an input layer of the feature extractor 650 in parallel to the image 60. The classifier 660 receives the number of the eyes from the output layer 630, and the output layer 670 outputs eye position information that corresponds to the number of the eyes received from the output layer 630.

Above, the described neural network and neural network configurations of FIGS. 2-6 may be implemented by the eye detection apparatus 100 of FIG. 1, for example, whose one or more processors may be configured to impellent any one, or any combination, or all such neural network or multi-level neural network structures.

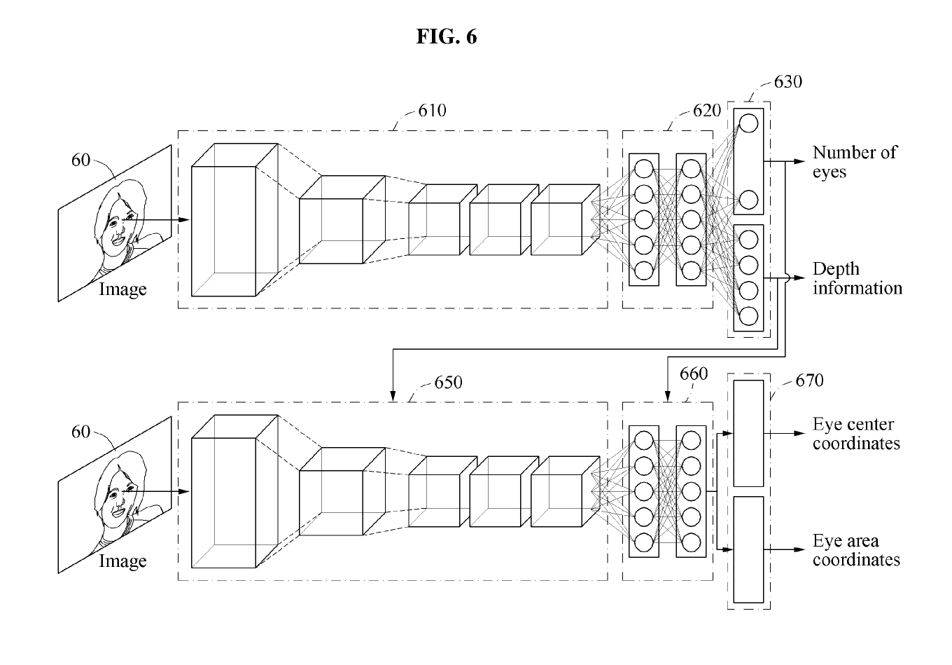

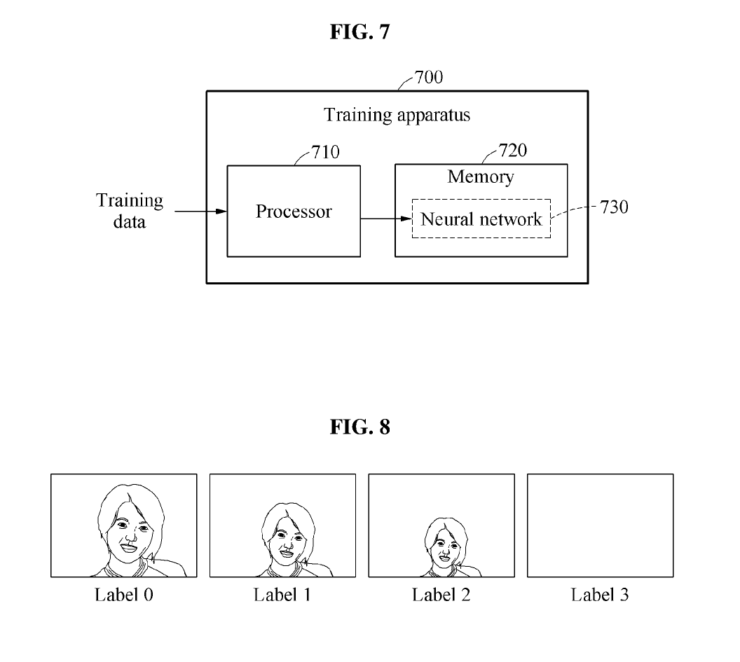

FIG. 7 illustrates an example of a training apparatus 700. Referring to FIG. 7, the training apparatus 700 includes a processor 710 and a memory 720. Here, the training apparatus may also correspond to the eye detection apparatus 100 of FIG. 1, for example, and also be configured to implement the remaining operations described herein. In an alternative example, the training apparatus 700 may be a separate system or server from the eye detection apparatus 100, for example. In addition, the training apparatus 700 and/or the eye detection apparatus 100 of FIG. 1 may be configured to train any of the neural networks or multi-level neural network configurations described above with respect to FIGS. 2-6, as non-limiting examples.

Thus, to implement such training, the processor 710 trains a neural network 730 based on training data. The training data may include a training input and training output. The training input includes a training image, and the training output may include a label that needs to be output from the neural network 730 in response to the training input. Thus, the training input may be referred to as being labeled training input, with the training output being mapped to the training input. For example, the training output includes at least one of a number of eyes, positions of the eyes, or a depth of one or more training subjects. The number of the eyes, the positions of the eyes and the depth of the training subject are mapped to the training image.

The processor 710 trains the neural network 730 to calculate the training output based on the training input. For example, the neural network 730 is input the training input, and a training output is calculated. Initially, the neural network 730 may have randomly set parameter values, or there may be an initial setting of preferred initiating training parameters values. The training of the neural network 730 includes adjusting each of the parameters of the neural network 730, through multiple runs or respective epochs of the neural network 730 training with the repetitively adjusted parameters. As noted above, the parameters of the neural network 730 may include, for example, connection weights for connections or links that connect nodes of the neural network 730, as well as respective kernel matrices that represent trained filters or feature extractors for respective convolutional layers. The neural network 730 includes, for example, the single-level neural network of FIG. 2 or the multi-level neural networks of FIGS. 3 through 6. When the neural network 730 is a single-level neural network, the processor 710 inputs a training image to the neural network 730 and trains the neural network 730 so that the neural network 730 determines at least one of a number of eyes, positions of the eyes, or a depth of a subject, e.g., thereby eventually training a neural network corresponding to FIG. 2, for example, by eventually generating the respective kernel matrices and connection weightings for the neural network 200. In this example, the number of the eyes, the positions of the eyes and the depth of the subject are mapped to the training image.

When the neural network 730 is a multi-level neural network, the neural network 730 includes a first neural network and a second neural network. In an example, the processor 710 inputs a training image to the first neural network, adjusts parameters of the first neural network so that the first neural network outputs a number of eyes included in the training image, and adjusts parameters of the second neural network so that the second neural network outputs depth information and eye position information, e.g., thereby eventually training a neural network corresponding to FIGS. 3-4, for example, by eventually generating the respective kernel matrices and connection weightings for the corresponding multi-level neural network. In this example, the depth information represents a distance between a subject and a camera that captures the training image, and the eye position information corresponds to the number of the eyes.

In another example, the processor 710 inputs a training image to the first neural network, and adjusts parameter of the first neural network so that the first neural network outputs a number of eyes included in the training image and depth information that represents a distance between a subject and a camera that captures the training image. Also, the processor 710 inputs, to the second neural network, the training image and the depth information output from the first neural network, and adjusts parameters of the second neural network so that the second neural network outputs eye position information that corresponds to the number of the eyes based on the depth information e.g., thereby eventually training a neural network corresponding to FIGS. 5-6, for example, by eventually generating the respective kernel matrices and connection weightings for the corresponding multi-level neural network.

The processor 710 trains connection weights between layers, and for respective and kernel matrices, of the neural network 730 using an error backpropagation learning scheme. For example, the processor 710 trains the neural network 730 using a supervised learning. The supervised learning is a scheme of inputting to a neural network a training input together with a training output corresponding to the training input and of updating connection weights to output the training output corresponding to the training input. For example, the processor 710 updates connection weights between nodes based on a delta rule and an error backpropagation learning scheme.

The error backpropagation learning scheme is a scheme of estimating an error by a forward computation of giving training data, propagating the estimated error backwards from an output layer to a hidden layer and eventually to an input layer, and adjusting the respective parameters, e.g., connection weights or kernel matrices, to reduce an error. A neural network is recognized in an order of an input layer, a hidden layer, and an output layer. However, the parameters may be updated in an order of an output layer, a hidden layer, and an input layer in the error backpropagation learning scheme.

The memory 720 stores the neural network 730. For example, the memory 720 stores a neural network updated sequentially during a training process, such as by updating previously stored parameter values from a previous adjustment increment, until finally trained parameters are finally stored in the memory 720. The stored final parameters may represent the trained neural network 730, and may thereafter be used by the training apparatus 700 as discussed above with respect to FIGS. 1-6. Alternatively, the training apparatus 700 may provide the finally trained parameters to another device, e.g., the eye detection apparatus 100 of FIG. 1, which may use the trained parameters to implement any of the above operations of FIGS. 1-6. Also, the memory 720 stores training data.

FIG. 8 illustrates an example of training data. FIG. 8 illustrates training data based on a depth of a subject. As described above, in the supervised learning, labels for learning are assigned to training data. The labels include, for example, at least one of a number of eyes, positions of the eyes or a depth of a training subject. For the depth, a preset number of levels may be defined.

For example, a level 1 representing a depth of “15” centimeters (cm), a level 2 representing a depth of “20” cm, a level 3 representing a depth of “25” cm, a level 4 representing a depth of “0” cm, and a level 5 representing an infinite depth are defined. The levels 4 and 5 indicate that a training subject does not exist in the image. In this example, a label 0 is assigned to training data showing a training subject corresponding to a distance of the level 1, a label 1 is assigned to training data showing a training subject corresponding to a distance of the level 2, and a label 2 is assigned to training data showing a training subject displaying a training subject corresponding to a distance of the level 3. Also, a label 3 is assigned to training data corresponding to the levels 4 and 5. A neural network is trained to output depth information based on the training data with the labels 0 through 3. When a distance between a training subject and a camera ranges from “15” cm to “25” cm, a depth of the training subject is recognized as one of the levels 1 through 3. When the distance between the training subject and the camera is less than “15” cm or exceeds “25” cm, an absence of the training subject in front of the camera is recognized.

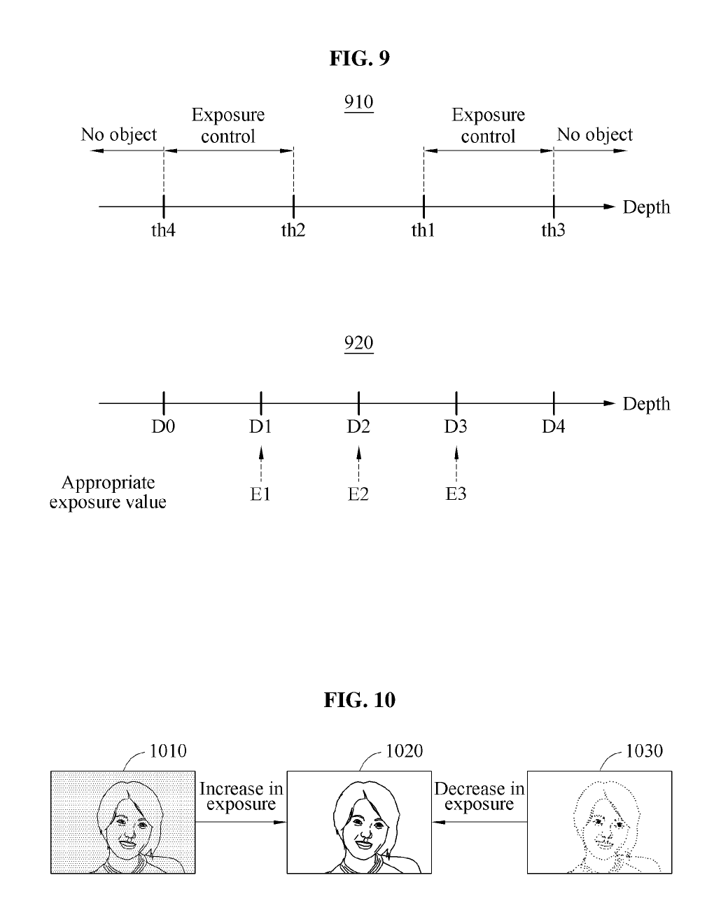

FIG. 9 illustrates an example of an exposure control based on a depth, such as may be performed by the eye detection apparatus 100 of FIG. 1 for a camera of the eye detection apparatus 100. In FIG. 9, an exposure control 910 is performed based on a threshold, and an exposure control 920 is performed based on an appropriate exposure value. In the exposure control 910, thresholds th1, th2, th3 and th4 for a depth are set in advance. As described above, a depth of a subject is estimated by a second neural network, and an exposure of an image is controlled based on a comparison of the thresholds th1 through th4 and the depth. Because the depth represents a distance between the subject and a camera that captures an input image, a depth value is understood to increase as the distance increases.

In an example, when the depth meets or exceeds the threshold th1, an accuracy of an eye detection may decrease due to an underexposure of the image. In this example, an eye detection apparatus increases an exposure of the image. In another example, when the depth does not meet or is less than the threshold th2, the accuracy of the eye detection may also decrease due to an overexposure of the image. In this example, the eye detection apparatus reduces the exposure of the image. In still another example, for an image corresponding to a depth that meets or exceeds the threshold th3 or an image corresponding to a depth that does not meet or is less than the threshold th4, an object is determined to be absent.

For example, a depth corresponding to the above-described label 0 is between the thresholds th1 and th3, and a depth corresponding to the above-described label 2 is between the thresholds th2 and th4. In this example, the eye detection apparatus increases an exposure of an image corresponding to the label 0 and reduces an exposure of an image corresponding to the label 2.

In the exposure control 920, an appropriate exposure value based on a depth is set in advance, e.g., in advance of the operation of the exposure control. For example, exposure values E1, E2 and E3 respectively corresponding to depths D1, D2 and D3 are set in advance. In this example, the eye detection apparatus estimates a depth of a subject and controls an exposure of an image based on an appropriate exposure value corresponding to the depth. When the depth D1 is estimated, the eye detection apparatus controls the exposure of the image to the exposure value E1. When the depth D2 is estimated, the eye detection apparatus controls the exposure of the image to the exposure value E2. When the depth D3 is estimated, the eye detection apparatus controls the exposure of the image to the exposure value E3. Also, the depths D1 through D3 correspond to labels 0 through 2, and depths D0 and D4 correspond to a label 3.

FIG. 10 illustrates an example of an exposure-controlled image. FIG. 10 illustrates an exposure-controlled image 1020, an underexposed image 1010 and an overexposed image 1030. In the underexposed image 1010 and the overexposed image 1030, an eye of a subject may not be detected, even though the subject actually exists in front of a camera, or an incorrect eye position may be detected. As described above, when the number of eyes is determined as zero based on an output of a neural network or when an appropriate exposure is required based on a depth of a subject, an eye detection apparatus controls an exposure of an image, in order to enhance an accuracy of an eye detection.

In an example, when an eye is not detected in the underexposed image 1010 or when a depth of a subject is determined to meet or be greater than a threshold in the underexposed image 1010, the eye detection apparatus controls the underexposed image 1010, or a for a next image frame capturing, to increase an exposure of the underexposed image 1010. In another example, when an eye is not detected in the overexposed image 1030 or when a depth of a subject is determined to not meet or to be less than a threshold in the overexposed image 1030, the eye detection apparatus controls the overexposed image 1030, or a for a next image frame capturing, to reduce an exposure of the overexposed image 1030. In still another example, when an exposure value of the underexposed image 1010 or the overexposed image 1030 is inappropriate for a depth of a subject in the underexposed image 1010 or the overexposed image 1030, an exposure of the underexposed image 1010 or the overexposed image 1030 is set by the eye detection apparatus to an appropriate exposure value for the depth.

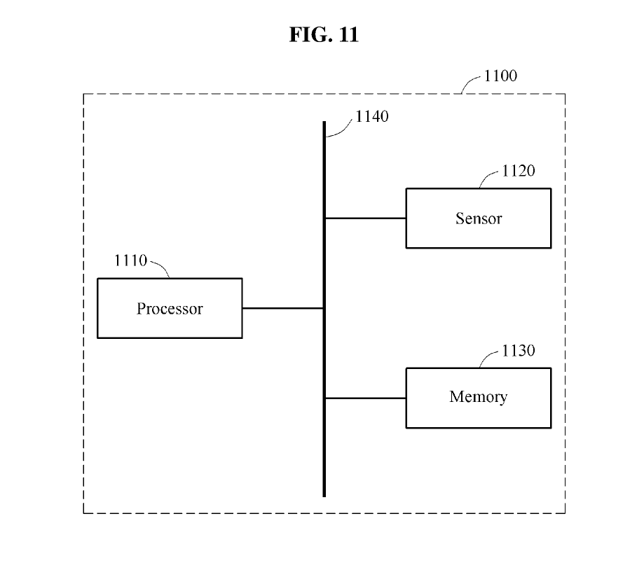

FIG. 11 illustrates an example of an eye detection apparatus 1100. Referring to FIG. 11, the eye detection apparatus 1100 includes a processor 1110, a sensor 1120, and a memory 1130. The processor 1110, the sensor 1120 and the memory 1130 communicate with each other via a bus 1140.

The sensor 1120 includes, for example, an infrared sensor and/or an image sensor either or both of which may be controlled by the processor 1110, for example, to capture an iris or a face of a subject. The sensor 1120 captures an iris or a face of a subject based on a well-known scheme, for example, a scheme of converting an optical image into an electrical signal. The sensor 1120 transmits a captured color image and/or infrared image to at least one of the processor 1110 or the memory 1130.

The processor 1110 is representative of one or more, any combination, or all of the apparatuses described above with reference to FIGS. 1 through 10, and may be configured to control and perform one or more, any combination, or all of the methods described above with reference to FIGS. 1 through 10. For example, the processor 1110 processes an operation associated with the above-described neural networks. For example, the processor 1110 may input an image to a neural network, and acquire eye position information that is included in the image and that is output from the neural network. The processor 1110 may be configured to implement any one, combination, or all of the above neural networks or multi-layer neural networks, such as based on corresponding trained parameters stored in the memory 1130. The processor 1110 may further correspond to the training apparatus 700 of FIG. 7.

The memory 1130 is a non-transitory computer readable medium that may further store computer-readable instructions, which when executed by the processor 1110, cause the processor 1110 to implement any one, combination, or all of the operations described above with respect to FIGS. 1-10, including instructions to configure the the processor 1110 to implement any one, combination, or all of the aforementioned neural networks and multi-level neural networks. Also, as noted, the memory 1130 stores the above-described neural network and data associated with the above-described neural network. For example, the memory 1130 stores the trained parameters and a membrane potential of the nodes of a particular neural network or multi-level neural network. The memory 1130 is, for example, a volatile memory or a nonvolatile memory.

The processor 1110 is configured to control the eye detection apparatus 1100. The eye detection apparatus 1100 may be connected to an external device (for example, a personal computer (PC) or a network) via an input/output device of the eye detection apparatus, and exchanges data with the external device. The eye detection apparatus 1100 is also representative of, or implemented as at least a portion of, for example, a mobile device such as a mobile phone, a smartphone, a personal digital assistant (PDA), a tablet computer or a laptop computer, a computing device such as a PC or a netbook, and an electronic product such as a television (TV), a smart TV or a security device for gate control.

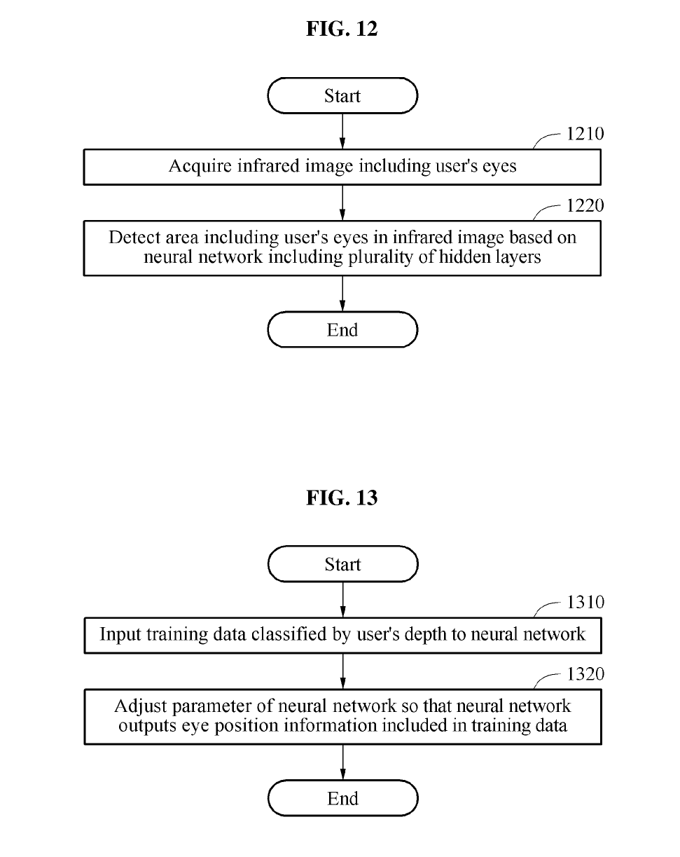

FIG. 12 illustrates an example of an eye detection method. Referring to FIG. 12, in operation 1210, an eye detection apparatus acquires an infrared image including eyes of a subject. In operation 1220, the eye detection apparatus detects an area including the eyes in the infrared image based on a neural network including a plurality of hidden layers. The above operation descriptions of FIGS. 1-11 are also included in and applicable to the eye detection method of FIG. 12, and accordingly are not repeated here.

FIG. 13 illustrates an example of a training method. Referring to FIG. 13, in operation 1310, a training apparatus inputs training data classified by a depth of a subject to a neural network. In operation 1320, the training apparatus adjusts parameters of the neural network so that the neural network outputs eye position information included in the training data. The above operation descriptions of FIGS. 1-11 are also included in and applicable to the training method of FIG. 13, and accordingly are not repeated here.

The eye detection apparatuses 100 and 1100, neural networks 110, 200, 310, 320, 510, 520, and 730, training apparatus 700, processors 710 and 1110, memory 720 and 1130, and sensor 1120 respectively in FIGS. 1-11 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented eye detection method comprising:
acquiring an infrared image; and
detecting an area comprising one or more eyes in the infrared image using a trained deep neural network comprising a plurality of hidden layers.

2. The method of claim 1, wherein the trained neural network comprises an interdependent multi-level neural network configured to detect a depth of the one or more eyes detected in the area.

3. The method of claim 2, further comprising controlling an exposure of a captured image and/or of a next captured image by an image sensor based on the detected depth.

4. The method of claim 2, wherein the multi-level neural network includes a first neural network provided the infrared image and configured to detect the depth and a second neural network provided the infrared image and the detected depth and configured to detect eye coordinates.

5. The method of claim 1, further comprising:
inputting, to a neural network, training data classified by a depth of a training subject in an image, the depth of the training subject representing a distance between the training subject and a camera that captured the training data; and
adjusting parameters of the neural network until the neural network outputs eye position information included in the training data with a predetermined confidence level, to generate the trained neural network.

6. The method of claim 1, wherein the trained neural network is configured to detect the area from the infrared image based on information about a distance between a subject in the infrared image and a camera that captures the infrared image, wherein the information about the distance is included in the infrared image.

7. The method of claim 6, wherein the information about the distance comprises information about a size of the one or more eyes in the infrared image.

8. The method of claim 1, wherein the trained neural network is configured to simultaneously determine, based on an input of the infrared image, at least two of a distance between a subject in the infrared image and a camera that captures the infrared image, a number of eyes included in the infrared image, or corresponding position(s) of the eye(s).

9. The method of claim 1, wherein the detecting comprises:
inputting the infrared image to the trained neural network; and
determining coordinates indicating a position of the area in the infrared image based on an output of the trained neural network.

10. A non-transitory computer-readable storage medium storing instructions that, when executed by a processor, cause the processor to implement the method of claim 1.

11. A processor-implemented eye detection method comprising:
inputting an image to a first neural network;
acquiring a number of eyes included in the image, the number of the eyes being output from the first neural network;
inputting the image to a second neural network; and
acquiring, as output from the second neural network, eye position information that corresponds to the number of the eyes and depth information that represents a distance between a subject in the image and a camera that captures the image.

12. The method of claim 11, further comprising:
controlling an exposure of the image based on at least one of the number of the eyes or the depth information.

13. The method of claim 12, further comprising:
inputting the image with the controlled exposure to the first neural network; and
acquiring eye position information included in the image with the controlled exposure based on an output of the first neural network in association with the image with the controlled exposure.

14. The method of claim 11, wherein
in response to an eye being determined to be included in the image, the second neural network is configured to output position information of a candidate object with a highest probability of corresponding to the eye among candidate objects estimated as the eye, and
in response to two eyes being determined to be included in the image, the second neural network is configured to output position information of two candidate objects with highest probabilities of corresponding to the eyes among candidate objects estimated as the eyes.

15. A processor-implemented eye detection method comprising:
inputting an image to a first neural network;
acquiring depth information of a subject in the image and a number of eyes included in the image, the depth information and the number of the eyes being output from the first neural network;
inputting the image and the depth information to a second neural network; and
acquiring eye position information that corresponds to the number of the eyes and that is output from the second neural network.

16. The method of claim 15, further comprising:
controlling an exposure of the image based on any one or combination of the number of the eyes or the depth information.

17. The method of claim 16, further comprising:
inputting the image with the controlled exposure to the first neural network; and
acquiring eye position information included in the image with the controlled exposure based on an output of the first neural network in association with the image with the controlled exposure.

18. The method of claim 15, wherein
in response to an eye being determined to be included in the image, the second neural network is configured to output position information of a candidate object with a highest probability of corresponding to the eye among candidate objects estimated as the eye, and
in response to two eyes being determined to be included in the image, the second neural network is configured to output position information of two candidate objects with highest probabilities of corresponding to the eyes among candidate objects estimated as the eyes.

19. A processor-implemented training method comprising:
inputting, to a neural network, training data classified by a depth of a subject in an image, the depth representing a distance between the subject and a camera that captured the training data; and
adjusting parameters of the neural network so that the neural network outputs eye position information included in the training data.

20. The method of claim 19, wherein the adjusting comprises adjusting the parameters of the neural network so that the neural network simultaneously determines at least two of a number of eyes included in the training data, positions of the eyes, or the depth.

21. The method of claim 19, wherein
the inputting comprises inputting the training data to each of a first neural network and a second neural network that are included in the neural network, and
the adjusting comprises:
adjusting parameters of the first neural network so that the first neural network outputs a number of eyes included in the training data; and
adjusting parameters of the second neural network so that the second neural network outputs the depth and eye position information that corresponds to the number of the eyes.

22. The method of claim 19, wherein
the inputting comprises inputting the training data to each of a first neural network and a second neural network that are included in the neural network, and
the adjusting comprises:
adjusting parameters of the first neural network so that the first neural network outputs the depth and a number of eyes included in the training data;
further inputting the depth to the second neural network; and
adjusting parameters of the second neural network so that the second neural network outputs eye position information that corresponds to the number of the eyes based on the depth.

23. An eye detection apparatus comprising:
a sensor configured to capture an infrared image; and
a processor configured to detect an area comprising one or more eyes of a subject in the infrared image using a trained deep neural network comprising a plurality of hidden layers.

24. The apparatus of claim 23, wherein the trained neural network is configured to detect the area from the infrared image based on information about a distance between the subject in the infrared image and the sensor, wherein the information about the distance is included in the infrared image.
